(19) United States
(12) Patent Application Publication
(10) Pub. No.: US 2011/0025115 A1
(43) Pub. Date: Feb. 3, 2011

(54) SEAT BACK STRUCTURE FOR SEAT FOR VEHICLE

(75) Inventor: Yukio TANAKA, Yokohama-shi (JP)

Correspondence Address: OLIFF & BERRIDGE, PLC, P.O. BOX 320850, ALEXANDRIA, VA, 22320-4850, US

(73) Assignee: NHK SPRING CO., LTD., Yokohama-shi (JP)

(21) Appl. No.: 12/846,084

(22) Filed: Jul. 29, 2010

(30) Foreign Application Priority Data
Aug. 3, 2009 (JP) 2009-180625

(51) Int. Cl. B60N 2/42

(52) U.S. Cl. 297/391

(57) ABSTRACT

A seat back structure reduces shocks from the rear, is simple and light, and has lower production costs. The center headrest stay inserting portions are on each proximate upper portion of each seat back of a half-half divisional type seat, respectively, and headrest stays extend from a center headrest downward are removably inserted in the headrest stay inserting portions, respectively, and the seat backs are connected and restrained by the headrest stays.

### BACKGROUND OF THE INVENTION

1. Technical Field

The present invention relates to a seat back structure for seats for vehicles.

2. Background Art

In vehicles such as passenger cars, etc., a conventional seat back structure, in which effects on an occupant are reduced by absorbing collision energy in a case in which a shock from the rear is loaded on a seat back by inertial force of the occupant when there is a rear collision has been known (for example, Japanese Unexamined Patent Application Publication No. 2008-105593).

In addition, in vehicles such as a station wagon, a one-compartment car, etc., an open baggage space may be formed behind a rear seat in the back. Therefore, in the case in which sudden braking occurs due to a collision, etc., during driving, cargo may suddenly move forward in the baggage space due to inertial force, and the cargo may collide with a back surface of the rear seat. When the cargo collides with the rear seat, the rear seat may be deformed and the occupants may be affected by the deformation. Therefore, a partition is formed between the baggage space and the occupant space by strengthening a structure of the rear seat. However, there is a problem in that weight is increased and production cost is also increased in order to strengthen the structure.

### SUMMARY OF THE INVENTION

Therefore, an object of the present invention is to provide a simple and light seat back structure which reduces shocks from the rear and which decreases production costs.

A seat back structure for seats for vehicles, of the present invention, has seat backs arranged in line by being adjoined in a right and left direction, headrest stay inserting portions is at each proximate upper portion of the adjoined seat backs, respectively, headrest stays which extend from a headrest downward are removably inserted to the headrest stay inserting portions, respectively, and the headrest is arranged across the adjoined seat backs.

According to the present invention, the two adjoined seat backs are connected by the headrest stays. In a case in which these connected seat backs are subjected to a shock from the rear, the seat backs are restrained by the headrest stays, thereby minimizing deformation thereof. As a result, the seat backs constitute a partition between the rear space (baggage space, etc.) and the front space for occupants. Therefore, a structure in which the headrest stays are inserted into the two adjoined seat backs can be simply and lightly realized, and production costs can be decreased.

In the present invention, it is preferable that the headrest stay have right and left rod portions which are inserted into the above headrest stay inserting portions, respectively, and which extend in an up and down direction, front extending portions which bend and extend from the upper portion of these rod portions forward of a car body, and a connecting bar portion for connecting these front extending portions which extend in a horizontal direction.

In addition, the present invention further includes two seat backs having the same width, in which a boundary between the two seat backs is placed at the center in a car width direction.

According to the present invention, a seat back structure which reduces shocks from the rear can be simply and lightly realized, and the production costs can be decreased.

### BRIEF DESCRIPTION OF THE DRAWINGS

FIG. 1 is a perspective view showing the rear seat back structure according to an embodiment of the present invention.

FIG. 2A is a side view showing a center headrest in an embodiment of the present invention, and FIG. 2B is a top view thereof.

FIG. 3 is a perspective view showing a feature deformed by a shock from the rear in the rear seat back according to an embodiment of the present invention.

FIG. 4 is a perspective view showing a feature deformed by a shock from the rear in a conventional rear seat back.

### BEST MODE FOR CARRYING OUT THE INVENTION

In the following, an embodiment of the present invention will be explained with reference to the drawings.

### (1) Structure of Rear Seat Back

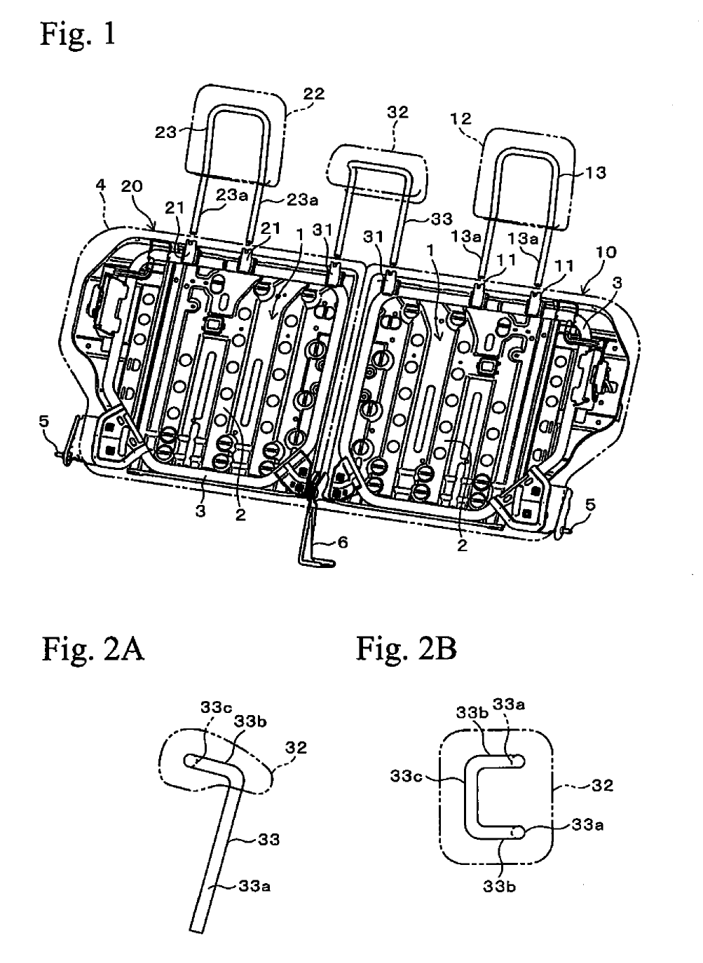

FIG. 1 shows a rear seat back placed in the back row of a vehicle such as a station wagon, a one-compartment type car, etc. This rear seat back has a left seat back 10, which is placed at the left side of the car body, and a right seat back 20, which adjoins at the right side of the left seat back 10. These right and left rear seat backs 10,20 are half-half divisional type seat backs having the same width, in which a boundary between the seat backs is placed at the center in a car width direction.

Each seat back 10,20 has a common structure, in which a cushion member 4 made of urethane, etc., which provides a skin material, is covered on a seat frame 1 including a frame panel 2 and a frame pipe 3. The outer sides of a lower portion of these right and left seat backs 10,20 are rotatably supported on a car body floor by pins 5, and the inner side of the lower portion is rotatably supported by a bracket 6, and as a result, the seat backs can be reclined in a front and back direction around a supporting portion as a supporting point.

On the upper portion of the right and left seat backs 10,20, right and left cylindrical headrest stay inserting portions 11,21 is provided by fixing to the frame pipe 3, respectively, and each headrest stay 13,23 for a left headrest 12 and a right headrest 22 is inserted into these headrest stay inserting portions 11,21. The headrest stay inserting portions 11,21 have stay holders (not shown) into which the headrest stays 13,23 are inserted, and a stopper mechanism, in which a position in a height direction of the headrest 12,22 can be adjusted by gradually stopping the headrest stays 13,23 during insertion, is provided in the stay holders. The right and left headrest stays 13,23 are formed in a reverse U-shape, and right and left rod portions 13 a and 23 a, which extend in an up and down direction, are removably inserted into the headrest stay inserting portions 11,21, and each headrest 12,22 is fixed to the upper portion thereof.

In addition, also on each proximate upper portion of the right and left seat backs 10,20, the same center headrest stay inserting portions 31 are fixed to the frame pipe 3, respectively. Then, headrest stays 33 of a center headrest 32 are inserted to these center headrest stay inserting portions 31.

The headrest stays 33 of the center headrest 32 include right and left rod portions 33a which are inserted into the center headrest stay inserting portions 31, respectively, and which extend in an up and down direction, front extending portions 33b which bend and extend from the upper portion of these rod portions 33a forward of the car body, and a connecting bar portion 33c for connecting these front extending portions 33b which extend in a horizontal direction, as shown in FIG. 2, and the headrest stays 33 have a reverse L-shape in side view.

The right and left rod portions 33a of the headrest stays 33 are removably inserted into the right and left center headrest stay inserting portions 31, and the center headrest 32 is fixed by covering the upper portion of the rod portions 33a, which is an upper portion of the headrest stays 33, the front extending portions 33b, and the connecting bar portion 33c. A stopper mechanism, in which a position in a height direction of the center headrest 32 can be adjusted by gradually stopping the headrest stays 33 during insertion, is provided in each center headrest stay inserting portion 31. The center headrest 32 is arranged across the right and left seat backs 10,20 by inserting the headrest stays 33 into the center headrest stay portion 31, respectively.

### (2) Effects

According to the rear seat back of the above embodiment, right and left seat backs 10,20 are connected by the headrest stays 33 of the center headrest 32. Here, in the case in which the right and left seat backs 10,20 connected by the headrest stays 33 receive a shock from the rear, deformation of the right and left seat backs 10,20 is minimized by restraining due to the headrest stays 33. Therefore, the right and left seat backs 10,20, that is, the entire rear seat back, constitutes a partition between the rear space (baggage space, etc.) and the front space for occupants.

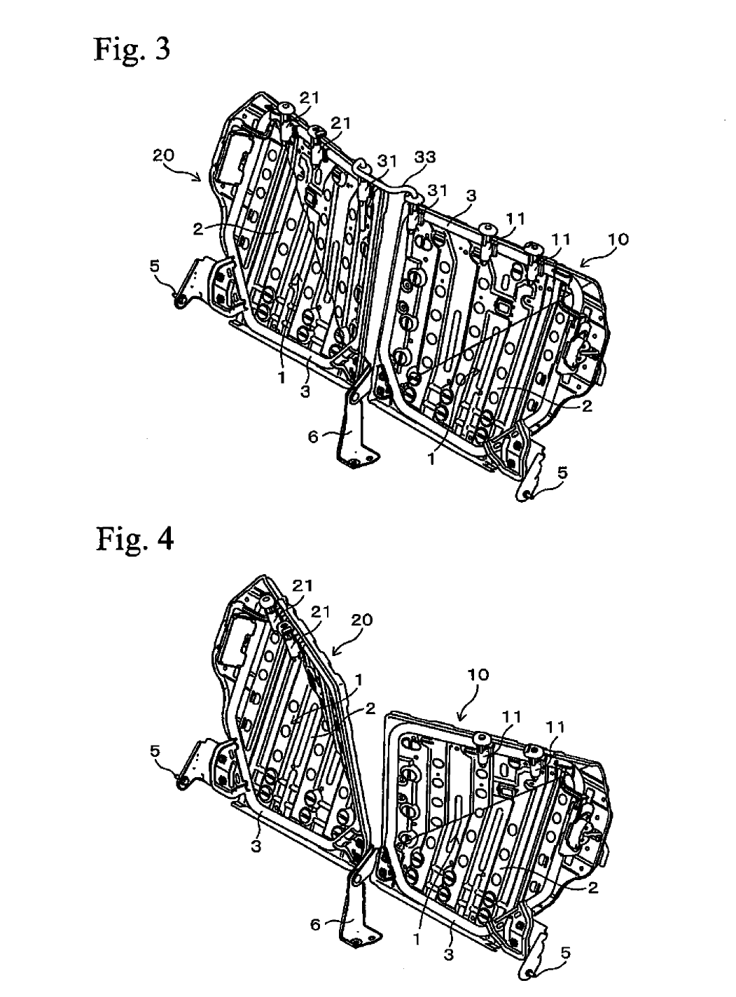

FIG. 3 shows a feature deformed by a shock from the rear to the center portion of the rear seat back. The right and left seat backs 10,20 are separated; however, the separation is controlled to be slight by headrest stays 33 for connecting the two seat backs, and the deformation thereof also is controlled to be small. In contrast, in the case in which the right and left seat backs 10,20 are not connected by the headrest stays 33, the right and left seat backs 10,20 are deformed by greatly inclining forward, and the upper portions thereof are greatly separated, as shown in FIG. 4.

Furthermore, the headrest stays 33 in the present embodiment are not simply reverse U-shaped such as the right and left headrest stays 13,23, and since the front extending portion 33b is arranged between the right and left rod portions 33a and the connecting bar 33c and the upper portions thereof are bended forward, the upper portions of the right and left seat backs 10,20 are easily separated by the presence of the front extending portion 33b. Therefore, the seat backs 10,20 have shock absorbability due to the deformation, and a protecting function, in which shocks are difficult to transmit to other members, the car body, etc., is also obtained, in addition to the above partition effect.

In addition, the structure in which the headrest stays 33 of the center headrest 32 are inserted into the right and left seat backs 10,20, can be simply and lightly realized, and the production costs can also be decreased. Furthermore, when the right and left seat backs 10,20 are half-half divisional type seat backs, the right and left seat backs 10,20 can have a common structure, and as a result, the number of parts and the type of parts are simplified and the production costs can be further decreased. Here, in the rear seat back of the present embodiment, the right and left seat backs 10,20 are contacted with each other and have a bench seat structure in which a front surface thereof is approximately flat, and each of the seat backs 10,20 can be independently reclined in a front and back direction, respectively.

What is claimed is:

1. A seat back structure for a seat for a vehicle, comprising:
seat backs arranged in line by adjoining in a right and left direction;
headrest stay inserting portions on each proximate upper portion of the adjoined seat backs;
headrest stays extending from a headrest downward removably inserted into the headrest stay inserting portions; and
the headrest is arranged across the adjoined seat backs.

2. The seat back structure according to claim 1,
the headrest stay comprising:
right and left rod portions inserted into the headrest stay inserting portions and extending in an up and down direction;
front extending portions which bend and extend from the upper portion of the rod portions forward of a car body; and
a connecting bar portion for connecting the front extending portions which extend in a horizontal direction.

3. The seat back structure according to claim 1, further comprising two seat backs having the same width, wherein a boundary between the two seat backs is placed at the center in a car width direction.
